(19) United States
(12) Patent Application Publication
(10) Pub. No.: US 2013/0240746 A1
(43) Pub. Date: Sep. 19, 2013

(54) ION SENSOR AND DISPLAY DEVICE

(71) Applicants: Atsuhito Murai, Osaka-shi (JP); Yoshiharu Kataoka, Osaka-shi (JP); Takuya Watanabe, Osaka-shi (JP); Yuhko Hisada, Osaka-shi (JP); Satoshi Horiuchi, Osaka-shi (JP)

(72) Inventors: Atsuhito Murai, Osaka-shi (JP); Yoshiharu Kataoka, Osaka-shi (JP); Takuya Watanabe, Osaka-shi (JP); Yuhko Hisada, Osaka-shi (JP); Satoshi Horiuchi, Osaka-shi (JP)

(21) Appl. No.: 13/701,123

(22) PCT Filed: May 18, 2011
(86) PCT No.: PCT/JP2011/061377

§ 371 Date: Dec. 11, 2012

(30) Foreign Application Priority Data
Jun. 3, 2010 (JP) 2010-128167

(51) Int. Cl. G01T 1/24

(52) U.S. Cl. CPC G01T 1/24
USPC 250/370.14

(57) ABSTRACT

The present invention provides an ion sensor and a display device which are capable of detecting positive ions and negative ions with high precision, at low cost. The ion sensor includes: a field effect transistor; an ion sensor antenna; and a capacitor, the ion sensor antenna and one terminal of the capacitor connected to a gate electrode of the field effect transistor, the other terminal of the capacitor receiving voltage.

### TECHNICAL FIELD

The present invention relates to an ion sensor and a display device. More specifically, the present invention relates to an ion sensor which measures the ion concentration with high precision and is suitable for use in devices such as an ion generator; and a display device provided with the ion sensor.

### BACKGROUND ART

A technology of generating positive ions and negative ions (hereinafter, also referred to as “both ions” or simply as “ions”) in the air has recently been found to have an effect of killing bacteria floating in the air and purify the air. An ion generator employing the technology, such as an air purifier, has matched the comfort and the recent trends towards health-conscious lifestyle, and thus has drawn much attention.

Since ions are invisible, checking generation of ions by direct eye-observation is not possible. Still, users of devices such as air purifiers naturally want to know if ions are successfully generated and if the ions generated have a desired concentration.

In this respect, Patent Literature 1, for example, discloses an air conditioner provided with an ion sensor for measuring the ion concentration in the air, and a display for displaying the ion concentration measured with the ion sensor.

An ion sensor of course is preferred to have high precision for precise measurement of the concentration of ions produced in the air.

In this respect, the following sensors are available. Patent Literature 2, for example, discloses a biosensor that changes the voltage to be applied to the back gate to adjust the electric potential of the gate electrode and suppress variation in threshold. Patent Literature 3, for example, discloses a field effect transistor ion sensor which includes a field effect transistor and an ion sensor integrally formed, and reduces the influence of measurement environment.

Also known is an ion generating element provided with an ion sensor portion for determining the amounts of positive ions and negative ions generated from the ion generating portion and a display for displaying the amounts of ions determined as described in, for example, Patent Literature 4. Furthermore, a remote control for electric appliances with a built-in ion sensor is known which is provided with an ion sensor for measuring the ion concentration in the air and a display for displaying the current state of the electric appliances, as described in, for example, Patent Literature 5.

### CITATION LIST

### Patent Literature

Patent Literature 1: JP H10-332164 A

Patent Literature 2: JP 2002-296229 A

Patent Literature 3: JP 2008-215974 A

Patent Literature 4: JP 2003-336872 A

Patent Literature 5: JP 2004-156855 A

### SUMMARY OF INVENTION

### Technical Problem

With an ion sensor utilizing the electric change of the gate connected to an ion sensor antenna (hereinafter also referred to as a “single gate sensor”), such as an ion sensor of Patent Literature 1, detection of the both ions of positive ions and negative ions with high precision results in a high cost.

A single gate sensor captures ions in the air by its ion sensor antenna. The electric potential Vg of the gate connected to the ion sensor antenna changes depending on the amount of the ions detected by the ion sensor antenna. The change in Vg leads to corresponding change in the drain current (Id). From the Id, the ion concentration is calculated.

The sensitivity of ion sensors is described. The electric potential of the antenna at the start of measuring the ion concentration is defined as V0. The electric potential of the antenna after measurement of the ion concentration for a predetermined time t is defined as Vt. The difference V0−Vt is defined as ΔV. The drain current at the start of the ion concentration measurement is defined as Id,0. The drain current after elapse of a predetermined time t is defined as Id,t. The difference Id, 0−Id,t is defined as ΔId. The sensitivity is represented by ΔId/ΔV. That is, a large value of ΔId compared to ΔV indicates higher sensitivity.

With reference to FIG. 11 and FIG. 12, the Id-Vg curve of a single gate sensor is described. This sensor includes an N-channel TFT 50 illustrated in FIG. 12. The TFT 50 is formed on a substrate 59, and includes a gate electrode 51, an insulating film 52, a hydrogenated a-Si layer 53, an n+a-Si layer 54, an electrode layer, an insulating film 57, and a back gate electrode 58. These components are stacked in the stated order from the substrate 59 side. The electrode layer includes a source electrode 55 and a drain electrode 56. The insulating film 57 is a SiNx film having a thickness of 350 nm. The n+a-Si layer 54 is doped with a V group element such as phosphorus (P). The gate electrode 51 is connected to an ion sensor antenna (not illustrated). FIG. 11 is a graph illustrating an Id-Vg curve of the TFT 50 illustrated in FIG. 12. The Id-Vg curve here is an electric potential (Vg) of the gate electrode 51 changed from −20 V to +20 V, with a fixed electric potential (Vb) of the back gate electrode 58 of 0 V. That is, FIG. 11 illustrates the Id-Vg curve in the case of operating the TFT 50 as a single gate sensor. The voltage between the source and the drain was set to +10 V.

In measurement of the negative ion concentration, a positive electric potential is applied to the ion sensor antenna to capture negative ions. At this time, a positive electric potential is applied to the gate electrode 51 connected to the ion sensor antenna, which means that ΔV indicates a difference between positive electric potentials. In this case, Id,0 and Id,t both are comparatively large, and ΔId can be determined with high precision. That is, in measurement of the negative ion concentration, results with considerably high precision are considered to be obtained.

Meanwhile, measurement of the positive ion concentration involves application of a negative electric potential for capturing positive ions. At this time, a negative electric potential is applied to the gate electrode 51 connected to the ion sensor antenna, which means that ΔV indicates a difference between negative electric potentials. At this time, Id,0 and Id,t both are very small, making it difficult to detect ΔId with high precision. That is, measurement of the positive ion concentration cannot produce results with high precision. This is because almost no drain current flows when the electric potential of the gate electrode 51 is negative in the N-channel TFT.

An ion sensor provided with a P-channel TFT is capable of determining the positive ion concentration with high precision, but has difficulty in determining the negative ion concentration with high precision.

In this way, determination of the concentrations of both ions is difficult with a single gate ion sensor provided with either an N-channel or P-channel TFT. For measurement of the concentrations of both ions, both the N-channel and P-channel TFTs are required, which leads to a high cost.

An ion sensor configured to measure the ion concentration using the electrical change of the back gate of the TFT (hereinafter, also referred to as a “double gate sensor”), such as the ion sensors of Patent Literatures 2 and 3, is now described.

A double gate sensor captures ions in the air by its ion sensor antenna. The electric potential Vb of the back gate connected to the ion sensor antenna changes depending on the amount of the ions detected by the ion sensor antenna. The electric potential Vg of a gate is set to a desired electric potential. The change in Vb leads to a corresponding change in the drain current (Id). From the Id, the ion concentration is calculated.

FIG. 13 is a graph illustrating an Id-Vg curve of the TFT 50 illustrated in FIG. 12. The Id-Vg curve here is an electric potential (Vb) of the back gate electrode 58 changed from −6 V to +6 V. That is, FIG. 13 illustrates the Id-Vg curve in the case of operating the TFT 50 as a double gate sensor. The voltage between the source and the drain was set to +10 V.

Use of a TFT having a back gate theoretically enables to detect both ions. Still, ΔId cannot be increased and detection of ions with high precision is difficult, without the following measures (1) or (2): (1) taking a large electric potential of the back gate that is proportional to the adsorbed amount of ions; and (2) making the distance between the back gate and the channel small. In the case of employing amorphous silicon (a-Si) advantageous in the cost effectiveness, Id itself needs to be set to a large value because a-Si has a lower degree of mobility than silicon such as polysilicon (p-Si). If the Id is not large, influences of noises or the like makes it difficult to detect ions with high precision. However, large Id drives TFTs in a region where Vg is higher than the threshold, which makes ΔId smaller, making it difficult to detect ions with high precision. In the case that the distance between the back gate and the channel is small, the yield of the TFTs decreases, which eventually leads to a high cost.

The present invention has been made in view of the above state of the art, and aims to provide an ion sensor capable of detecting positive ions and negative ions with high precision at a low cost; and a display device.

### Solution to Problem

The present inventors have made various studies on an ion sensor capable of detecting positive ions and negative ions with high precision at a low cost. The inventors have found that connecting the capacitor to the gate electrode of the transistor enables to push up the electric potential Vg to a positive value or push it down to a negative value, thereby shifting the Vg to a value in a voltage region suitable for detection of ions with high precision. As a result, the present inventors have found that an ion sensor provided with only one of either an N-channel TFT or P-channel TFT is capable of detecting both positive ions and negative ions with high precision. Thereby, the above problem has been successfully solved, and the present invention has been completed.

That is, one aspect of the present inventions is an ion sensor including: a field effect transistor; an ion sensor antenna; and a capacitor, the ion sensor antenna and one terminal of the capacitor connected to a gate electrode of the field effect transistor, the other terminal of the capacitor receiving voltage.

Hereinafter, the ion sensor is described in detail.

The ion sensor includes a field effect transistor (hereinafter, also referred to as an “FET”). The electrical resistance of the channel of the FET changes depending on the detected concentration of ions. The ion sensor detects the change as a current or voltage change between the source and drain of the FET.

The FET may be of any kind, but is preferably a thin film transistor (hereinafter, also referred to as a “TFT”) or a metal oxide semiconductor FET (MOSFET). A TFT is suitable for an active-matrix driven liquid crystal display device or an organic electro-luminescence (organic EL) display device. A MOSFET is suitable for a semiconductor chip for components such as LSIs and ICs.

Any semiconductor material may be used for TFTs.

Examples of the material include amorphous silicon (a-Si), polysilicon (p-Si), microcrystalline silicon (μc-Si), continuous grain silicon (CG-Si), and oxide semiconductors. Any semiconductor material may be used for MOSFETs.
Examples of the material include silicon.

The ion sensor further includes an ion sensor antenna (hereinafter also simply referred to as an “antenna”) which is connected to the gate electrode of the field effect transistor. The antenna is a conductive component that detects (captures) ions in the air. More specifically, ions reaching the antenna charge the surface of the antenna, which leads to an electric potential change of the gate electrode of the FET that is connected to the antenna. The change results in a change in the electrical resistance of the channel of the FET.

The ion sensor further includes a capacitor. One terminal of the capacitor is connected to the gate electrode of the field effect transistor, and the other terminal of the capacitor receives voltage. When the current or voltage value between the source and drain of the FET is measured, such a capacitor enables to push up the electric potential of the gate of the FET to a positive value in the case that the FET is of N-channel conduction, and the capacitor also enables to push down the electric potential of the gate of the FET to a negative value in the case that the FET is of P-channel conduction. The electric potential of the gate of an N-channel or P-channel FET can be shifted to a value in a voltage region suitable for detecting ions with high precision. As a result, an N-channel or P-channel conduction FET alone can detect both positive ions and negative ions with high precision. Since only one of either an N-channel conduction FET or P-channel conduction FET is required, the production cost can be reduced.

The capacitor may be of any kind, but is preferably a capacitor having a single plate structure. The capacitor can be formed simultaneously with the electrodes and wirings of the FET, which enables cost reduction.

The ion sensor including these components as its essential components is not particularly limited by other components.

In the following, a preferable embodiment of the ion sensor is described in detail.

The voltage applied to the other terminal of the capacitor is preferably variable. With a variable voltage, the amount of Vg to be pushed up or pushed down can be appropriately adjusted. The Vg therefore can be easily shifted to a value in the appropriate voltage region.

The ion sensor may have the following structure: the field effect transistor is a first field effect transistor, the ion sensor antenna is a first ion sensor antenna, the capacitor is a first capacitor, the ion sensor further comprises a second field effect transistor, a second ion sensor antenna, and a second capacitor, the second ion sensor antenna and one terminal of the second capacitor are connected to a gate electrode of the second field effect transistor, the other terminal of the second capacitor receives voltage, and the first capacitor and the second capacitor are different from each other in capacitance.

Accordingly, application of the same voltage to the first and second capacitors produces an appropriate amount of Vg to be pushed up or pushed down in a circuit including the first FET and a circuit including the second FET.

The first and second FETs each preferably contain a-Si or μc-Si. The mobility of a-Si and μc-Si is lower than that of silicons such as p-Si. Detection of both ions with high precision has been especially difficult with a conventional double gate sensor containing a-Si or μc-Si. In contrast, the above ion sensor can detect positive ions and negative ions with high precision also in the case of containing a-Si or μc-Si. That is, the effect of the present invention can be particularly effectively achieved.

The present invention, employing comparatively inexpensive a-Si or μc-Si, can provide an ion sensor capable of detecting both ions with high precision at a low cost.

Another aspect of the present invention is a display device provided with the ion sensor, a display including a display-driving circuit, and a substrate. The field effect transistor, the ion sensor antenna, and at least one portion of the display-driving circuit are formed on the same main surface of the substrate. Thereby, the ion sensor can be provided in a vacant space (e.g., picture-frame region) of the substrate, and the ion sensor can be formed using the process of forming the display-driving circuit. As a result, a display device can be produced which is provided with the ion sensor and the display, can be produced at a low cost, and can be miniaturized.

The display device may be of any kind, and its suitable examples include flat panel displays (FPDs). Examples of the FPDs include liquid crystal display devices, organic electroluminescence displays, and plasma displays.

The display includes elements for performing the display functions, and includes, for example, display elements and optical films in addition to the display-driving circuit. The display-driving circuit is a circuit for driving the display elements, and includes, for example, circuits such as a TFT array, a gate driver, and a source driver. Particularly, a TFT array is preferably used as the at least one portion of the display-driving circuit.

The display element has a light-emitting function or light-controlling function (shutter function for light), and is provided for each pixel or sub-pixel of the display device.

For example, a liquid crystal display device usually includes a pair of substrates, and has display elements having a light-controlling function between the substrates. More specifically, the display elements of the liquid crystal display device each usually include a pair of electrodes, and liquid crystals placed between the substrates.

An organic electroluminescence display usually has display elements having a light-emitting function on a substrate. More specifically, the display elements of the organic EL display each usually have a structure in which an anode, an organic electroluminescence layer, and a cathode are stacked.

A plasma display usually has a pair of substrates facing each other, and display elements having a light-emitting function which are placed between the substrates. More specifically, the light-emitting elements of the plasma display usually include a pair of electrodes; a fluorescent material formed on one of the substrates; and rare gas enclosed between the substrates.

The display device having the above components as its essential components is not particularly limited by other components.

Preferred embodiments of the display device are described in detail below. The structures of the first FET and the first ion sensor antenna can also be applied to the second FET and the second ion sensor antenna.

The FET is the first FET. The display-driving circuit includes the third FET. The first FET, the ion sensor antenna (first ion sensor antenna), and the third FET are preferably formed on the same main surface of the substrate. With these structures, at least part of the materials and processes for forming the first and third FETs can be the same, and thus the cost required for formation of the first and third FETs can be reduced.

A device provided with a conventional ion sensor and a display usually utilizes parallel plate electrodes for the ion sensor. For example, the ion sensor of Patent Literature 4 is provided with a plate-shaped accelerating electrode and a plate-shaped capturing electrode which face each other. Such a parallel plate ion sensor cannot be processed easily on the order of micrometers because of the limit of processing accuracy in production. Hence, miniaturization of the ion sensor is difficult. Also on the remote control for electric appliances with a built-in ion sensor described in Patent Literature 5, a parallel plate electrode, consisting of a pair of an ion-accelerating electrode and an ion-capturing electrode, is provided. Miniaturization of such an ion sensor is also difficult. In contrast, use of an FET and an ion sensor antenna for an ion sensor element as in the above structure allows production of the ion sensor element by photolithography. Thereby, the ion sensor can be processed on the order of micrometers, and therefore can be more miniaturized than the parallel plate ion sensors. The electrode gap (gap between the TFT array substrate and counter substrate) in the liquid crystal display device is usually about 3 to 5 μm. In the case that an electrode is provided to each of the TFT array substrate and the counter substrate such that a parallel plate ion sensor is formed, introduction of ions into the gap is considered difficult. Meanwhile, since the ion sensor element including an FET and an antenna as in the above structure eliminates the need for a counter substrate, the display device provided with the ion sensor can be miniaturized.

The ion sensor element is an element that is minimum required to convert the ion concentration in the air to an electric, physical amount.

The third FET may be of any kind, but is preferably a TFT. TFTs are suitable for active-matrix driven liquid crystal display devices and organic EL display devices.

The semiconductor material may be any material in the case that the third FET is a TFT. Examples of the semiconductor material include a-Si, p-Si, μc-Si, CG-Si, and oxide semiconductors. Particularly, a-Si and μc-Si are preferred.

The ion sensor antenna (first ion sensor antenna) preferably has a surface (exposed portion) including a transparent conductive film. That is, the surface of the ion sensor antenna is preferably covered by a transparent conductive film. This structure prevents the unexposed portion (e.g. portion including metal wirings) of the antenna from being exposed to the external environment, and thereby prevents the unexposed portion from being corroded.

The transparent conductive film is the first transparent conductive film, and the display preferably includes the second transparent conductive film. Since the transparent conductive film has conductivity and optical transparency, the second transparent conductive film can be suitable for use as a transparent electrode of the display. Also, at least part of the materials and processes for the first transparent conductive film and the second transparent conductive film can be the same. Accordingly, the first transparent conductive film can be formed at a low cost.

The first transparent conductive film and the second transparent conductive film preferably contain the same material(s), and more preferably consist only of the same material(s). Such a structure enables to form the first transparent conductive film at a low cost.

The material of each of the first transparent conductive film and the second transparent conductive film may be any material. For example, indium tin oxide (ITO), indium zinc oxide (IZO), zinc oxide (ZnO), and fluorine-doped tin oxide (FTO) are suitable.

The first FET preferably includes a semiconductor whose properties are changed by light, and the semiconductor is preferably shielded from light by a light-shielding film. Examples of the semiconductor whose properties are changed by light include a-Si and μc-Si. In order to use these semiconductors for an ion sensor, the light is preferably blocked such that the properties do not change. Shielding, from light, the semiconductor whose properties are changed by light enables suitable use of the semiconductor not only for a display but also for an ion sensor.

The light-shielding film shields the first FET from light outside the display device (external light) and/or light inside the display device. Examples of the light inside the display device include reflected light produced inside the display device. In the case that the display device is a spontaneous light emission display device such as an organic EL display and a plasma display, examples of the light inside the display device include light emitted from the light-emitting elements provided in the display device. Meanwhile, in the case of a non-spontaneous light emission liquid crystal display device, examples of the light inside the display device include light from the backlight. The reflected light produced inside the display device is about several tens of lux, and the influence on the first FET is comparatively small. Examples of the external light include sunlight and interior illumination (e.g., fluorescent lamp). The sunlight is 3000 to 100000 Lx, and the interior fluorescent lamp at the time of actual use (except for use in a dark room) is 100 to 3000 Lx. Both lights greatly influence the first FET. The light-shielding film preferably shields the first FET from at least the external light, and more preferably blocks both the external light and the light inside the display device.

Preferably, the light-shielding film is the first light-shielding film, and the display has the second light-shielding film. With such a structure, in the case that a liquid crystal display device or an organic EL display is used as the display device of the present invention, the second light-shielding film can be provided at borders between the pixels or sub-pixels in the display for prevention of color mixing. Also, at least part of the materials and processes for forming the first light-shielding film and the second light-shielding film can be the same, and therefore the first light-shielding film can be formed at a low cost.

The first light-shielding film and the second light-shielding film preferably contain the same material(s), and more preferably consist only of the same material(s). The first light-shielding film therefore can be formed at a low cost.

The ion sensor antenna (first ion sensor antenna) may or may not overlap the channel region of the first FET. Since the antenna usually does not include a semiconductor whose properties are changed by light, light shielding is not necessary. That is, in the case that the first FET needs to be shielded from light, a light-shielding film is not necessary around the antenna. Accordingly, provision of an antenna outside the channel region (i.e., the antenna does not overlap the channel region) enables free choice of the antenna arrangement position regardless of the first FET arrangement position. The free choice allows easy formation of an antenna at places where ions can be effectively detected, such as a place near a channel or fan for introducing the air to the antenna. In contrast, provision of an antenna in the channel region (i.e., the antenna overlaps the channel region) allows the gate electrode of the first FET itself to function as an antenna. The ion sensor element therefore can be further miniaturized.

At least one portion of the ion sensor and at least one portion of the display-driving circuit are preferably connected to a common power supply. With use of a common power supply, the cost for forming the power supply and the arrangement space for the power supply can be reduced compared to the structure in which the ion sensor and the display have different power supplies. More specifically, at least the source or drain of the first FET and the gates of the TFTs in the TFT array are preferably connected to the common power supply.

The display device may be used for any product. Suitable examples of the product include non-portable displays such as displays for televisions and personal computers. To such a non-portable display, the ion concentration in the indoor environment in which the display is placed can be displayed. The suitable examples also include portable devices such as cell phones and personal digital assistants (PDAs). With such a product, the ion concentration at various places can be measured easily. The suitable examples further include ion generators provided with a display. Such an ion generator can show on the display the concentration of ions emitted from the ion generator.

### ADVANTAGEOUS EFFECTS OF INVENTION

The present invention can provide an ion sensor and a display device which are capable of detecting positive ions and negative ions with high precision at a low cost.

### BRIEF DESCRIPTION OF DRAWINGS

FIG. 1 is a block diagram of an ion sensor and a display device according to Embodiments 1 and 2.

FIG. 2 is a schematic cross-sectional view illustrating the cross section of the ion sensor and the display device according to Embodiments 1 and 2.

FIG. 3 is a schematic cross-sectional view illustrating the cross section of the ion sensor and the display device according to the Embodiments 1 and 2.

FIG. 4 is an equivalent circuit illustrating an ion sensor circuit 107 and a TFT array 101 according to Embodiments 1 and 2.

FIG. 5 is a timing chart of the ion sensor circuit according to Embodiment 1.

FIG. 6 is a graph illustrating an Id-Vg curve of the ion sensor and display device according to Embodiment 1.

FIG. 7 is a timing chart of the ion sensor circuit according to Embodiment 1.

FIG. 8 is a graph illustrating an Id-Vg curve in the ion sensor and display device according to Embodiment 1.

FIG. 9 is a timing chart of the ion sensor circuit according to Embodiment 2.

FIG. 10 is a timing chart of the ion sensor circuit according to Embodiment 2.

FIG. 11 is an Id-Vg curve in a single gate sensor.

FIG. 12 is a schematic cross-sectional view of a TFT provided with a back gate.

FIG. 13 is an Id-Vg curve in a double gate sensor.

FIG. 14 is an equivalent circuit illustrating an ion sensor circuit according to an alternative embodiment.

FIG. 15 is a timing chart of a negative ion detection circuit and a positive ion detection circuit according to the alternative embodiment.

FIG. 16 is an equivalent circuit illustrating a part of the ion sensor circuit according to Embodiment 1.

FIG. 17 is an equivalent circuit illustrating a part of another ion sensor circuit according to Embodiment 1.

### DESCRIPTION OF EMBODIMENTS

The present invention is described in more detail based on the following embodiments, with reference to the drawings. The present invention is not limited to the embodiments.

### Embodiment 1

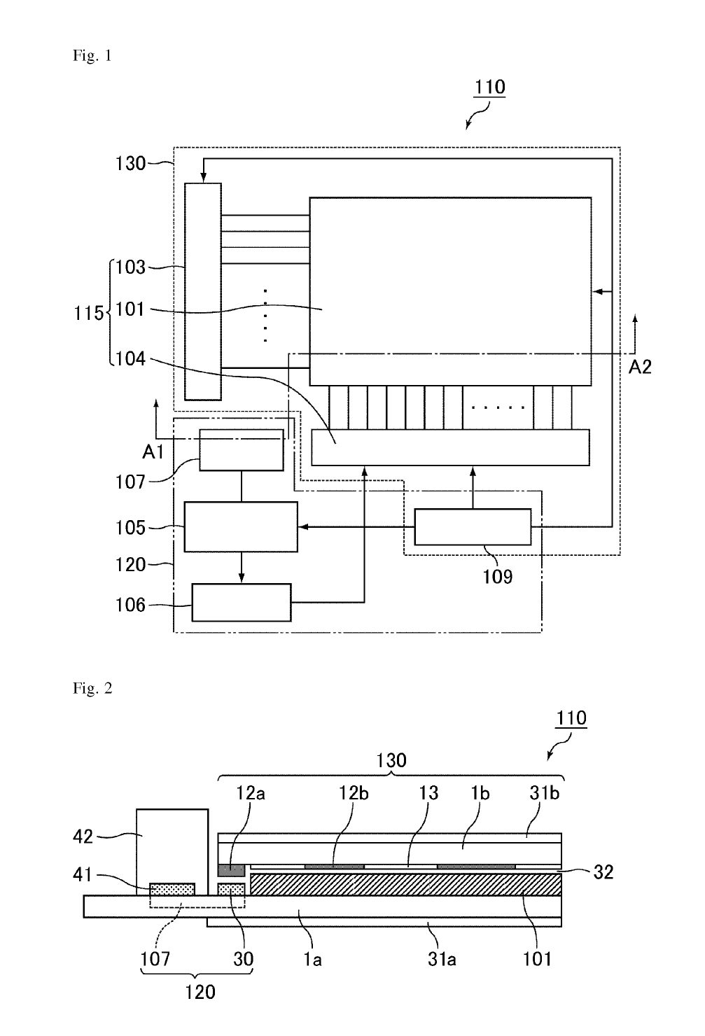

The present embodiment is described based on examples of an ion sensor including N-channel TFTs and configured to detect ions in the air, and a liquid crystal display device including the ion sensor. FIG. 1 is a block diagram of an ion sensor and a display device according to the present embodiment.

A display device 110 according to the present embodiment is a liquid crystal display device, and includes an ion sensor 120 (ion sensor portion) for measuring the ion concentration in the air, and a display 130 for displaying various images. The display 130 is provided with a display-driving circuit 115 that includes a display-driving TFT array 101, a gate driver (scanning signal line-driving circuit for display) 103, and a source driver (image signal line-driving circuit for display) 104. The ion sensor 120 includes an ion sensor driving/reading circuit 105, an arithmetic processing LSI 106, and an ion sensor circuit 107. A power supply circuit 109 is shared by the ion sensor 120 and the display 130. The ion sensor circuit 107 is a circuit that includes at least elements (preferably an FET and an ion sensor antenna) required to convert the ion concentration in the air to an electric physical amount, and has a function of detecting (capturing) ions.

The display 130 has the same circuit structure as a conventional active-matrix display device such as a liquid crystal display device. That is, images are displayed in a region with the TFT array 101 formed, i.e., in a display region, by line sequential driving.

The function of the ion sensor 120 is summarized below. First, the ions in the air are detected (captured) in the ion sensor circuit 107, and a voltage value corresponding to the detected amount of ions is generated. The voltage value is transmitted to the driving/reading circuit 105 where the value is converted into a digital signal. The signal is transmitted to the LSI 106, such that the ion concentration is calculated by a certain calculation method, and display data for displaying the calculation result in the display region is generated. The display data is transmitted to the TFT array 101 through a source driver 104, and the ion concentration corresponding to the display data is eventually displayed. The power supply circuit 109 supplies electric power to the TFT array 101, the gate driver 103, the source driver 104, and the driving/reading circuit 105. The driving/reading circuit 105 controls the later-described push-up/push-down line, reset line, and input line as well as the above functions, and supplies a certain amount of electric power to each line in desired timing.

The driving/reading circuit 105 may be included in another circuit such as the ion sensor circuit 107, the gate driver 103, and the source driver 104, and may be included in the LSI 106.

In the present embodiment, the arithmetic processing may be performed using software that functions on a personal computer (PC) in place of the LSI 106.

The structure of the display device 110 is described using FIG. 2. FIG. 2 is a schematic cross-sectional view of the ion sensor and the display device which were cut along the line A1-A2 illustrated in FIG. 1. The ion sensor 120 is provided with the ion sensor circuit 107, an air ion lead-in/lead-out path 42, a fan (not illustrated), and a light-shielding film 12a (first light-shielding film). The ion sensor circuit 107 contains the ion sensor element that includes a sensor TFT (first FET) 30 and an ion sensor antenna 41. The display 130 is provided with the TFT array 101 including pixel TFTs (third FETs) 40, a light-shielding film 12b (second light-shielding film), a color filter 13 including colors such as RGB and RGBY, liquid crystals 32, and polarizers 31a and 31b.

The antenna 41 is a conductive member for detecting (capturing) ions in the air, and is connected to the gate of the sensor TFT 30. The antenna 41 includes a portion to be exposed to the external environment (exposure portion). Ions adhering to the surface (exposure portion) of the antenna 41 change the electric potential of the antenna 41, which changes the electric potential of the gate of the sensor TFT 30. As a result, the electric current and/or voltage between the source and drain in the sensor TFT 30 change(s). Thus, an ion sensor element including the antenna 41 and the sensor TFT 30 can be miniaturized compared to the conventional parallel plate ion sensor.

The lead-in/lead-out path 42 is a path for efficiently ventilating the space above the antenna 41. The fan blows air from the observation side to the depth side of FIG. 2, or from the depth side to the observation side.

The display device 110 is provided with two insulating substrates 1a and 1b which face each other in the most part, and the liquid crystals 32 disposed between the substrates 1a and 1b. The sensor TFT 30 and the TFT array 101 are provided on the main surface on the liquid crystal side of the substrate 1a (TFT array substrate) in the region where the substrates 1a and 1b face each other. The TFT array 101 includes pixel TFTs 40 arranged in a matrix state. The antenna 41, lead-in/lead-out path 42, and fan are arranged on the liquid crystal-side main surface of the substrate 1a in the region where the substrates 1a and 1b do not face each other. In this way, the antenna 41 is formed outside the channel regions of the sensor TFT 30. Thereby, the antenna 41 can be easily arranged near the lead-in/lead-out path 42 and the fan, efficiently sending air to the antenna 41. Also, the sensor TFT 30 and the light-shielding film 12a are formed at the end (picture-frame region) of the display 130. The arrangement leads to effective use of the space in the picture-frame region, and therefore the ion sensor circuit 107 can be formed without a change of the size of the display device 110.

On the one same main surface of the substrate 1a, at least the sensor TFT 30 and the ion sensor antenna 41 included in the ion sensor circuit 107, and the TFT array 101 included in the display-driving circuit 115 are formed. Accordingly, the sensor TFT 30 and the ion sensor antenna 41 can be formed using the process of forming the TFT array 101.

The light-shielding films 12a and 12b and the color filter 13 are provided on the liquid crystal-side main surface of the substrate 1b (counter substrate) in the region where the substrates 1a and 1b face each other. The light-shielding film 12a is formed at a position facing the sensor TFT 30, and the light-shielding film 12b and the color filter 13 are formed at a position facing the TFT array 101. The sensor TFT 30 includes a-Si which is a semiconductor whose properties are changed by light, as described in more detail later. Shielding the sensor TFT 30 from light with the light-shielding film 12a enables to reduce the property change of a-Si, i.e., the output property change of the sensor TFT 30. Thereby, the ion concentration can be measured with higher precision.

The polarizers 31a and 31b are formed on the respective main surfaces on the opposite side to the liquid crystals (outer side) of the substrates 1a and 1b.

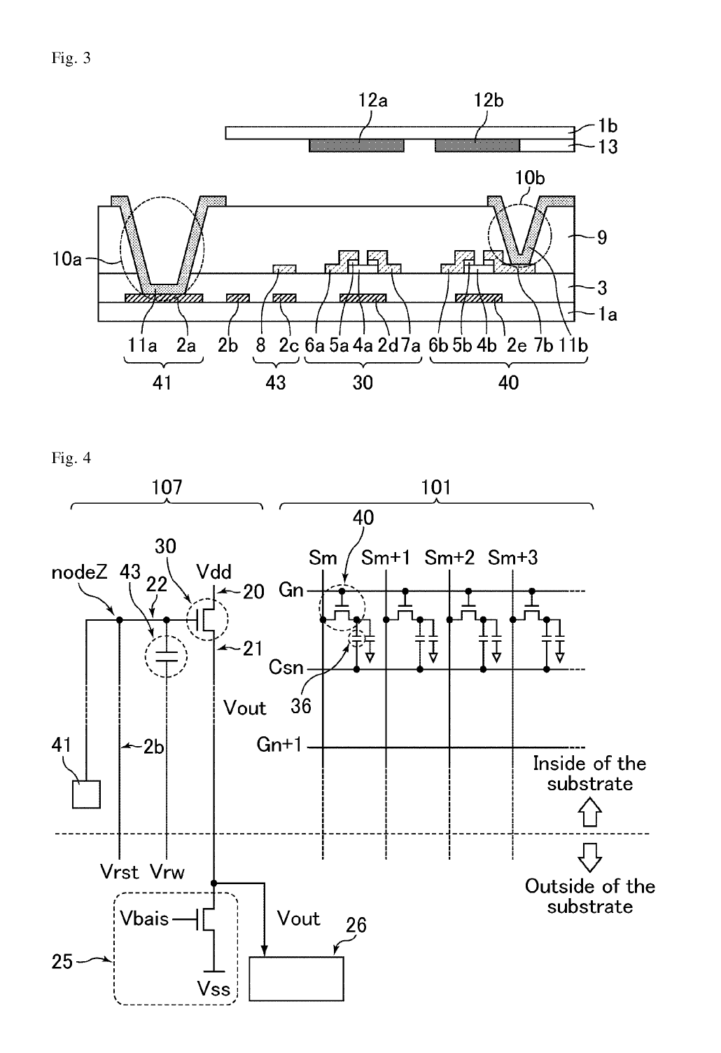

The structure of the display device 110 is described in more detail with reference to FIG. 3. FIG. 3 is a schematic cross-sectional view of the ion sensor and the display device according to the present embodiment.

On the liquid crystal-side main surface of the insulating substrate 1a, a first conductive layer, an insulating film 3, a hydrogenated a-Si layer, an n+a-Si layer, a second conductive layer, a passivation film 9, and a third conductive layer are stacked in the stated order.

In the first conductive layer, an ion sensor antenna electrode 2a, a reset line 2b, a later-described connection line 22, a push-up/push-down capacitor electrode 2c, and gate electrodes 2d and 2e are formed. These electrodes are formed in the first conductive layer, and can be formed by, for example, sputtering and photolithography from the same material through the same process. The first conductive layer is formed from a single or multiple metal layers. Specific examples of the first conductive layer include a single aluminum (Al) layer, a laminate of lower layer of Al/upper layer of titanium (Ti), and a laminate of lower layer of Al/upper layer of molybdenum (Mo). The reset line 2b, the connection line 22, and the capacitor electrode 2c are described below in more detail with reference to FIG. 4.

The insulating film 3 is formed on the substrate 1a in such a manner as to cover the ion sensor antenna electrode 2a, the reset line 2b, the connection line 22, the push-up/push-down capacitor electrode 2c, and the gate electrodes 2d and 2e. On the insulating film 3, hydrogenated a-Si layers 4a and 4b, n+a-Si layers 5a and 5b, source electrodes 6a and 6b, drain electrodes 7a and 7b, and a push-up/push-down capacitor electrode 8 are formed. The source electrodes 6a and 6b, the drain electrodes 7a and 7b, and the capacitor electrode 8 are formed in the second conductive layer, and can be formed by sputtering and photolithography from the same material through the same process. The second conductive layer is formed from a single or multiple metal layers. Specific examples of the second conductive layer include a single aluminum (Al) layer, a laminate of lower layer of Al/upper layer of Ti, and a laminate of lower layer of Ti/upper layer of Al. The hydrogenated a-Si layers 4a and 4b can be formed by, for example, chemical vapor deposition (CVD) and photolithography from the same material through the same process. The n+a-Si layers 5a and 5b can also be formed by, for example, CVD and photolithography from the same material through the same process. In this way, at least part of the materials and processes can be the same in forming the electrodes and semiconductors. The cost required in formation of the sensor TFT 30 and the pixel TFTs 40 including the electrodes and semiconductors therefore can be reduced. The components of the TFTs 30 and 40 are described in more detail later.

The passivation film 9 is formed on the insulating film 3 in such a manner as to cover the hydrogenated a-Si layers 4a and 4b, n+a-Si layers 5a and 5b, source electrodes 6a and 6b, drain electrodes 7a and 7b, and capacitor electrode 8. On the passivation film 9, a transparent conductive film 11a (first transparent conductive film) and a transparent conductive film 11b (second transparent conductive film) are formed. The transparent conductive film 11a is connected to the antenna electrode 2a via a contact hole 10a that penetrates the insulating film 3 and the passivation film 9. The transparent conductive film 11a is arranged to prevent the antenna electrode 2a from being exposed to the external environment because of the contact hole 10a. Hence, the arrangement makes it possible to prevent corrosion of the antenna electrode 2a as a result of being exposed to the external environment. The transparent conductive film 11b is connected to the drain electrode 7b via a contact hole 10b which penetrates the passivation film 9. These transparent electrodes 11a and 11b are formed in the third conductive layer, and can be formed by, for example, sputtering and photolithography from the same material through the same process. The third conductive layer is formed from a single or multiple transparent conducing films. Specific examples of the transparent conductive films include ITO films and IZO films. The materials constituting the transparent conductive films 11a and 11b are not required to be completely the same as each other. The processes for forming the transparent conductive films 11a and 11b are not required to be completely the same as each other either. For example, in the case that the transparent conductive film 11a and/or the transparent conductive film 11b have/has a multilayer structure, it is also possible to form only layer(s) common to the two transparent conductive films from the same material through the same process. Applying at least part of the materials and processes for forming the transparent conductive film 11b as described above to formation of the transparent conductive film 11a enables to form the transparent conductive film 11a at a low cost.

The light-shielding film 12a and the light-shielding film 12b can also be formed from the same material through the same process. Specifically, the light-shielding films 12a and 12b are formed from opaque metal (e.g. chromium (Cr)) films, opaque resin films, or other films. Examples of the resin films include acrylic resins containing carbon. Applying at least part of the materials and processes for forming the light-shielding film 12b as described above to formation of the light-shielding film 12a enables to form the light-shielding film 12a at a low cost.

The components of the TFTs 30 and 40 are described in more detail. The sensor TFT 30 is formed from the gate electrode 2d, the insulating film 3, the hydrogenated a-Si layer 4a, the n+a-Si layer 5a, the source electrode 6a, and the drain electrode 7a. The pixel TFTs 40 each are formed from the gate electrode 2e, the insulating film 3, the hydrogenated a-Si layer 4b, the n+a-Si layer 5b, the source electrode 6b, and the drain electrode 7b. The insulating film 3 functions as a gate insulating film in the sensor TFT 30 and the pixel TFTs 40. The TFTs 30 and 40 are bottom-gate TFTs. The n+a-Si layers 5a and 5b are doped with a V group element such as phosphorus (P). That is, the sensor TFT 30 and the pixel TFTs 40 are N-channel TFTs.

The antenna 41 includes the transparent conductive film 11a and the antenna electrode 2a. The push-up/push-down capacitor electrodes 2c and 8 and the insulating film 3 configured to function as a dielectric form the push-up/push-down capacitor 43 which is a capacitor. The capacitor electrode 2c is connected to the gate electrode 2d and the antenna electrode 2a. The capacitor electrode 8 is connected to a push-up/push-down line 23. Thereby, the capacitance of the gate electrode 2d and the antenna 41 can be increased, which enables to suppress the extraneous noise during the measurement of the ion concentration. Accordingly, more stable sensor operation and higher precision can be achieved. Also, both ions can be detected with high precision as described in detail later.

Next, the circuit configuration and the movement mechanism of the ion sensor circuit 107 and the TFT array 101 are described using FIG. 4. FIG. 4 is a view illustrating an equivalent circuit of portions of the ion sensor circuit 107 and the TFT array 101 according to the present embodiment.

First, the TFT array 101 is described. The gate electrodes 2d of the pixel TFTs 40 are connected to the gate driver 103 via the gate bus lines Gn, Gn+1, and so forth. The source electrodes 6b are connected to the source driver 104 via the source bus lines Sm, Sm+1, and so forth. The drain electrodes 7b of the pixel TFTs 40 are connected to the transparent conductive films 11b which function as pixel electrodes. The pixel TFTs 40 are provided in the respective sub-pixels, and function as switching elements. The gate bus lines Gn, Gn+1, and so forth receive scanning pulses (scanning signals) in predetermined timings from the gate driver 103. The scanning pulses are applied to each pixel TFT 40 by a line sequential method. The source bus lines Sm, Sm+1, and so forth receive any image signals provided by the source driver 104 and/or display data calculated based on the negative ion concentration. Then, the image signals and/or display data are/is transmitted, in predetermined timing, to the pixel electrodes (transparent conductive films 11b) connected to the pixel TFTs 40 that are turned on for a certain period by inputted scanning pulses. The image signals and/or display data at a predetermined level written to the liquid crystals are stored for a certain period between the pixel electrodes having received these signals and/or data and the counter electrode (not illustrated) facing the pixel electrodes. Here, together with the liquid crystal capacitors formed between the pixel electrodes and the counter electrode, liquid crystal storage capacitors (Cs) 36 are formed. The liquid crystal storage capacitor 36 is formed between the drain electrode 7a and the liquid crystal auxiliary capacitor line Csn, Csn+1, or the like in the respective sub-pixels. The capacitor lines Csn, Csn+1, and so forth are formed in the first conductive layer, and are disposed in parallel with the gate lines Gn, Gn+1, and so forth.

Next, the circuit configuration of the ion sensor circuit 107 is described. The drain electrode 7a of the sensor TFT 30 is connected to an input line 20. The input line 20 receives high voltage (+10 V) or low voltage (0 V). The voltage of the input line 20 is indicated by Vdd. The source electrode 6a is connected to an output line 21. The voltage of the output line 21 is indicated by Vout. The gate electrode 2d of the sensor TFT 30 is connected to the antenna 41 via the connection line 22. The connection line 22 is connected to the reset line 2b. The intersection (node) of the lines 22 and 2b is indicated by node-Z. The reset line 2b is a line for resetting the voltage of the node-Z, i.e., the voltage of the gate of the sensor TFT 30 and the antenna 41. The reset lines 2b receive high voltage (+20 V) or Low voltage (−10 V). The voltage of the reset line 2b is indicated by Vrst. The connection line 22 is connected to the push-up/push-down line 23 via the push-up/push-down capacitor 43. The push-up/push-down line 23 receives high voltage or low voltage (for example, −10 V). The voltage of the push-up/push-down line 23 is indicated by Vrw. The high voltage and the low voltage for Vrw, i.e., the waveform of Vrw, can be adjusted to desired values by changing the values of the power supplies for supplying the respective high voltage and low voltage. Examples of the method of changing the value of the power supplies include the following methods (1) and (2).

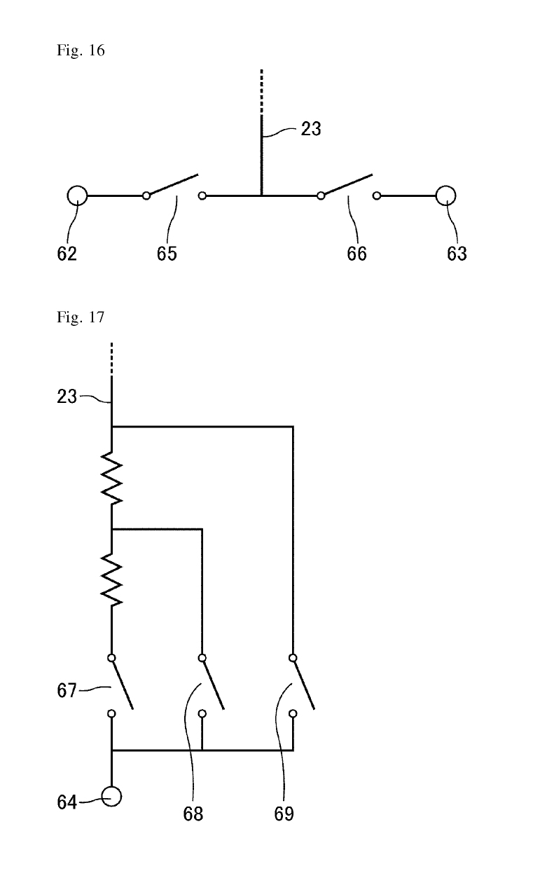

(1) The method of preparing multiple power supplies, and changing the power supply connected to the line 23 using a switch (e.g. semiconductor switch, transistor). Here, which power supply to connect, i.e., the connection destination of the switch, is controlled by signals from the host. More specifically, the method may be, as illustrated in FIG. 16, a method of preparing power supplies 62 and 63 having different power supply values, and switching the power supply connected to the line 23 using respective switches 65 and 66.

(2) The method of connecting a resistor ladder to one power supply, and selecting the voltage (resistance) to be output. Which voltage (resistance) to connect is controlled by signals from the host. More specifically, the method may be, as illustrated in FIG. 17, a method of connecting the power supply 64 to a resistor ladder, and selecting the desired voltage (resistance) to be output by turning on or off switches 67, 68, and 69.

The output line 21 is connected to a constant current circuit 25 and an analog-digital conversion circuit (ADC) 26. The constant current circuit 25 includes an N-channel TFT (constant current TFT), and the drain of the constant current TFT is connected to the output line 21. The source of the constant current TFT is connected to a constant current source, and the voltage Vss is fixed to a voltage lower than the high voltage for Vdd. The gate of the constant current TFT is connected to a constant-voltage source. The voltage Vbais of the gate of the constant current TFT is fixed to a predetermined value so that fixed electric current (for example, 1 μA) flows between the source and drain of the constant current TFT. The constant current circuit 25 and ADC 26 are formed within a driving/reading circuit 105.

The antenna electrode 2a, the gate electrode 2d, the reset line 2b, the capacitor electrode 2c, and the connection line 22 are integrally formed in the first conductive layer such that the antenna 41, the gate of the sensor TFT 30, the reset line 2b, the connection line 22, and the push-up/push-down capacitor 43 are connected to each other. In contrast, the driving/reading circuit 105, the gate driver 103, and the source driver 104 each are not formed directly on the substrate 1a, but are formed on a semiconductor chip. The semiconductor chip is then mounted on the substrate 1a.

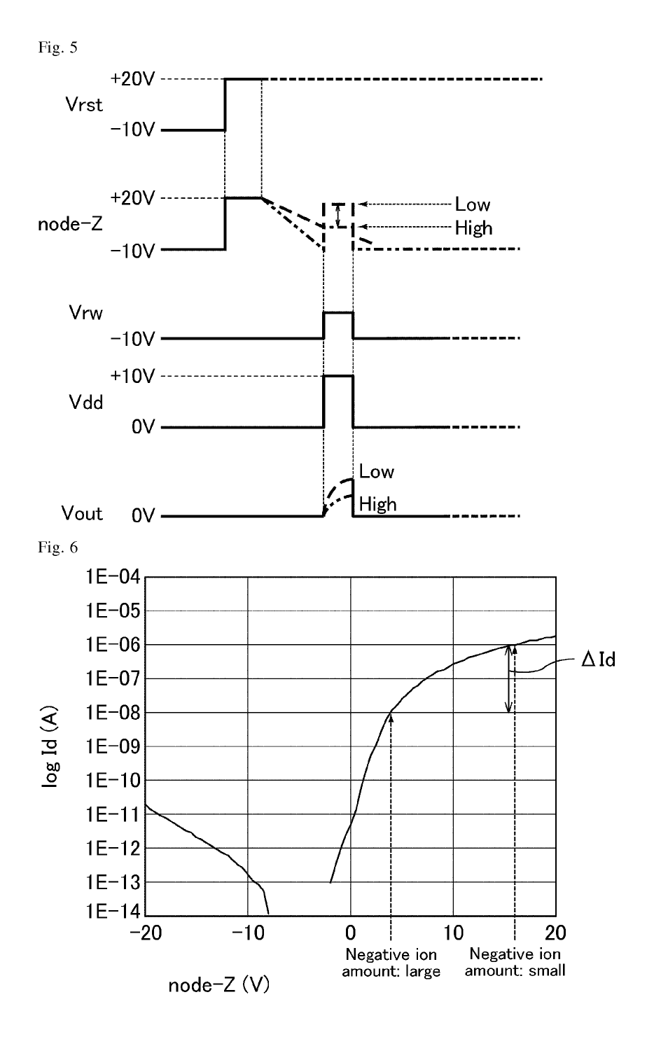

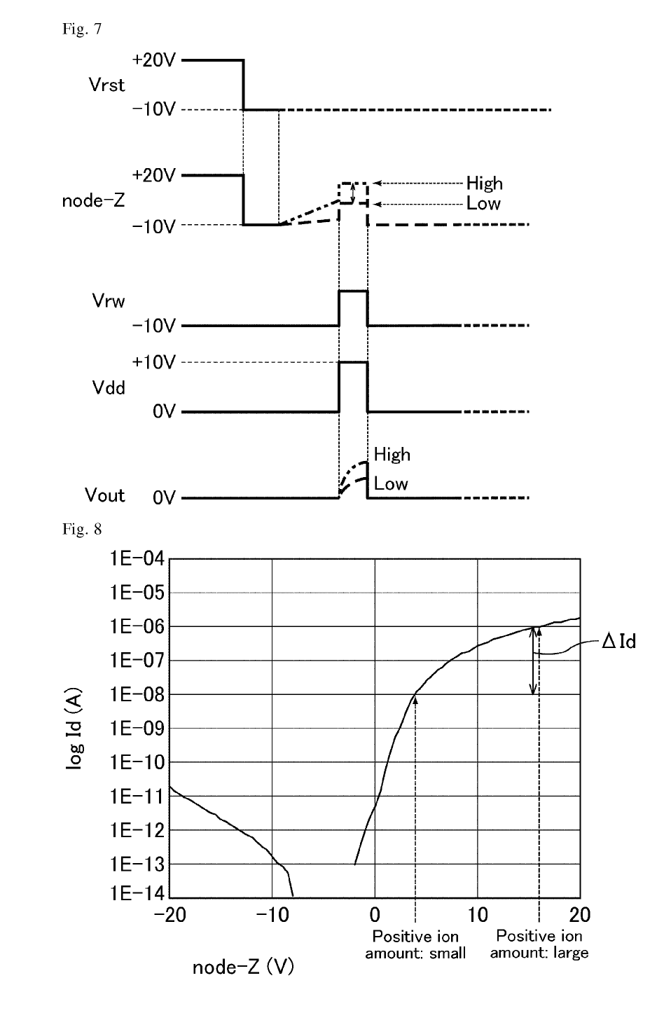

The operating mechanism of the ion sensor circuit is described in detail using FIGS. 5 to 8. FIG. 5 is a timing chart of the ion sensor circuit according to the present embodiment in measurement of the negative ion concentration. FIG. 6 is a graph showing the Id-Vg curve in the ion sensor and display device according to the present embodiment. FIG. 7 is a timing chart of the ion sensor circuit according to the present embodiment in measurement of the positive ion concentration. FIG. 8 is a graph showing the Id-Vg curve in the ion sensor and display device according to the present embodiment.

First, the measurement of the negative ion concentration is described using FIGS. 5 and 6. In the initial state, Vrst is set to the low voltage (−10 V). At this time, the power supply for setting Vrst to the low voltage (−10 V) can be the power supply for applying the low voltage (−10 V) to the gate electrode 2e of the pixel TFT 40. Also in the initial state, Vdd is set to the low voltage (0 V). Before measurement of the ion concentration, the high voltage (+20 V) is applied to the reset line 2b to reset the voltage (voltage of node-Z) of the antenna 41 to +20 V. At this time, the power supply for setting the reset line 2b to the high voltage (+20 V) can be the power supply for applying the high voltage (+20 V) to the gate electrode 2e of the pixel TFT 40. After the voltage of node-Z is reset, the reset line 2b is maintained in a high impedance state. When ions are started to be introduced and the antenna 41 captures negative ions, the voltage of the node-Z which has been reset to +20 V, i.e., charged to be positive, is neutralized by the negative ions and decreased (sensing operation). A higher negative ion concentration leads to a higher speed of the voltage decrease. After elapse of a predetermined time from introduction of ions, the high voltage (+10 V) is temporarily applied to the input line 20. That is, the input line 20 receives a pulse voltage of 10 V. At the same time, an appropriate positive pulse voltage (high voltage) is applied to the push-up/push-down line 23, such that the voltage of the node-Z is pushed up via the push-up/push-down capacitor 43. The output line 21 is connected to the constant current circuit 25. Therefore, application of a pulse voltage of +10 V to the input line 20 leads to a constant current flow in the input line 20 and the output line 21. The voltage Vout of the output line 21 changes depending on how much the gate of the sensor TFT 30 is opened, i.e., the difference in voltage of the node-Z caused by pushing up the voltage. Detection of the voltage Vout with the ADC 26 enables to detect the negative ion concentration. The negative ion concentration can also be detected by detecting the current Id of the output line 21 changing depending on the difference in node-Z voltage, without provision of the constant current circuit 25. The positive voltage to be applied to the push-up/push-down line 23 is set such that Vg is in the voltage region with the value of ΔId/ΔVg being the desired value or higher as illustrated in FIG. 6, i.e., a high S/N ratio is achieved. Therefore, the voltage of the node-Z is not necessarily pushed up if Vg is in the voltage region suitable for detection of the negative ion concentration without pushing up the voltage of the node-Z.

The measurement of the positive ion concentration is described using FIGS. 7 and 8. In the initial state, Vrst is set to the high voltage (+20 V). At this time, the power supply for setting Vrst to the high voltage (+20 V) can be the power supply for applying the high voltage (+20 V) to the gate electrode 2e of the pixel TFT 40. Also in the initial state, Vdd is set to the low voltage (0 V). Before measurement of the ion concentration, the low voltage (−10 V) is applied to the reset line 2b to reset the voltage (voltage of node-Z) of the antenna 41 to −10 V. At this time, the power supply for setting the reset line 2b to the low voltage (−10 V) can be the power supply for applying the low voltage (−10 V) to the gate electrode 2e of the pixel TFT 40. After the voltage of node-Z is reset, the reset line 2b is maintained in a high impedance state. When ions are started to be introduced and the antenna 41 captures positive ions, the voltage of the node-Z which has been reset to −10 V, i.e., charged to be negative, is neutralized by the positive ions and increased (sensing operation). A higher positive ion concentration leads to a higher speed of the voltage increase. After elapse of a predetermined time from introduction of ions, a high voltage (+10 V) is temporarily applied to the input line 20. That is, the input line 20 receives a pulse voltage of 10 V. At the same time, an appropriate positive pulse voltage (high voltage) is applied to the push-up/push-down line 23, such that the voltage of the node-Z is pushed up via the push-up/push-down capacitor 43. The output line 21 is connected to the constant current circuit 25. Therefore, application of a pulse voltage of +10 V to the input line 20 leads to a constant current flow in the input line 20 and the output line 21. The voltage Vout of the output line 21 changes depending on how much the gate of the sensor TFT 30 is opened, i.e., the difference in voltage of the node-Z caused by pushing up the voltage. Detection of the voltage Vout with the ADC 26 enables to detect the positive ion concentration. The positive ion concentration can also be detected by detecting the current Id of the output line 21 changing depending on the difference in node-Z voltage, without provision of the constant current circuit 25. The positive voltage to be applied to the push-up/push-down line 23 is set such that Vg is in the voltage region with the value of ΔId/ΔVg being the desired value or higher as illustrated in FIG. 8, i.e., a high S/N ratio is achieved.

In the present embodiment, the high voltage for Vdd is not particularly limited to +10 V, and may be +20 V which is the same as the high voltage applied to the reset line 2b, i.e., the high voltage applied to the gate electrode 2e of the pixel TFT 40. In this case, the power supply for setting Vdd to the high voltage can be the power supply for applying the high voltage to the gate electrode 2e of the pixel TFT 40. The voltage (low voltage for Vrw) of the push-up/push-down line 23 without pushing up the voltage of the node-Z may be −10 V which is the same as the low voltage applied to the gate electrode 2e of the pixel TFT 40. At this time, the power supply for setting Vrw to the low voltage can be the power supply for applying the low voltage to the gate electrode 2e of the pixel TFT 40. The voltage (high voltage for Vrw) of the push-up/push-down line 23 in pushing up the voltage of the node-Z is appropriately set such that the value of ΔId/ΔVg is large as described above.

### Embodiment 2

The display device according to Embodiment 2 has the same structure as that in Embodiment 1 except for the following points. That is, the display device according to Embodiment 1 has an ion sensor capable of measuring the ion concentration in the air using the N-channel sensor TFT 30. The display device according to Embodiment 2 has an ion sensor capable of measuring the ion concentration in the air using a P-channel sensor TFT 30.

More specifically, p+a-Si layers are formed instead of the n+a-Si layers 5a and 5b, and are doped with a group III element such as boron (B). That is, the sensor TFT 30 and the pixel TFTs 40 according to the present embodiment are P-channel TFTs.

The push-up/push-down line 23 receives a high voltage (e.g., +20 V) or low voltage, and the low voltage for Vrw can be adjusted to a desired value.

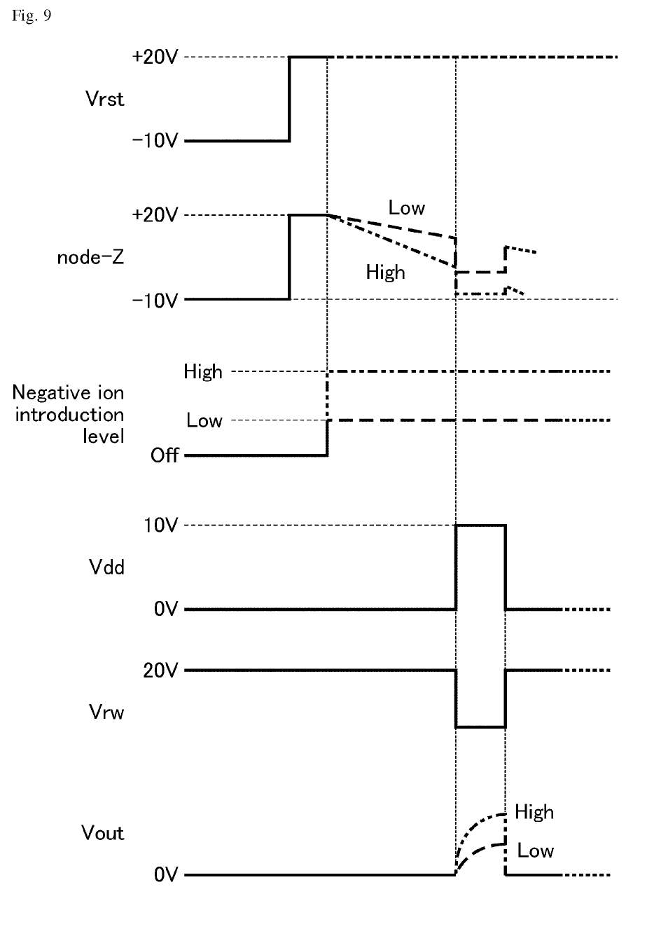

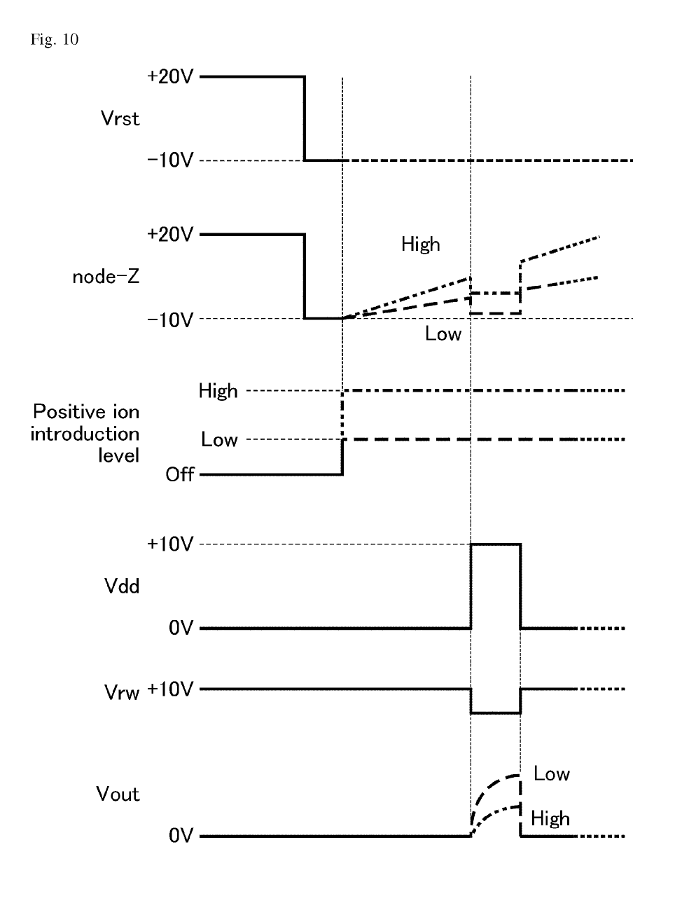

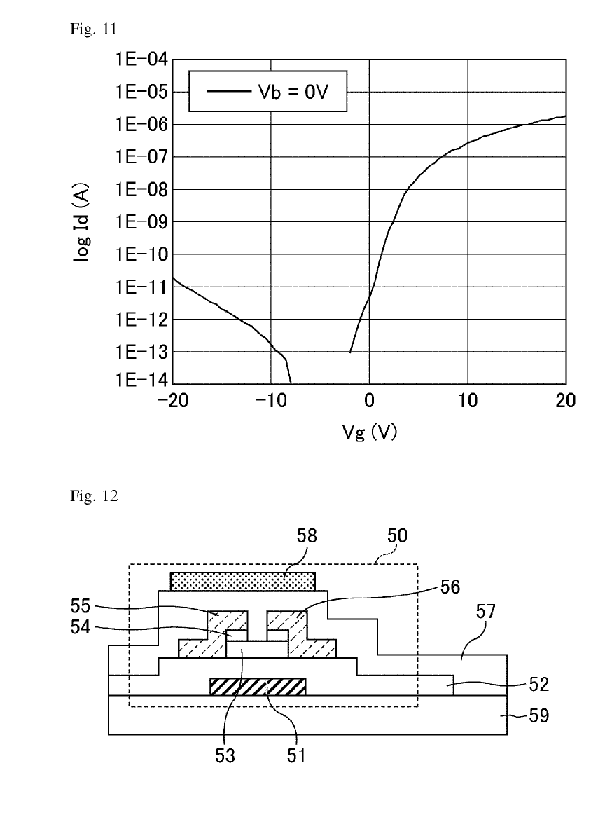

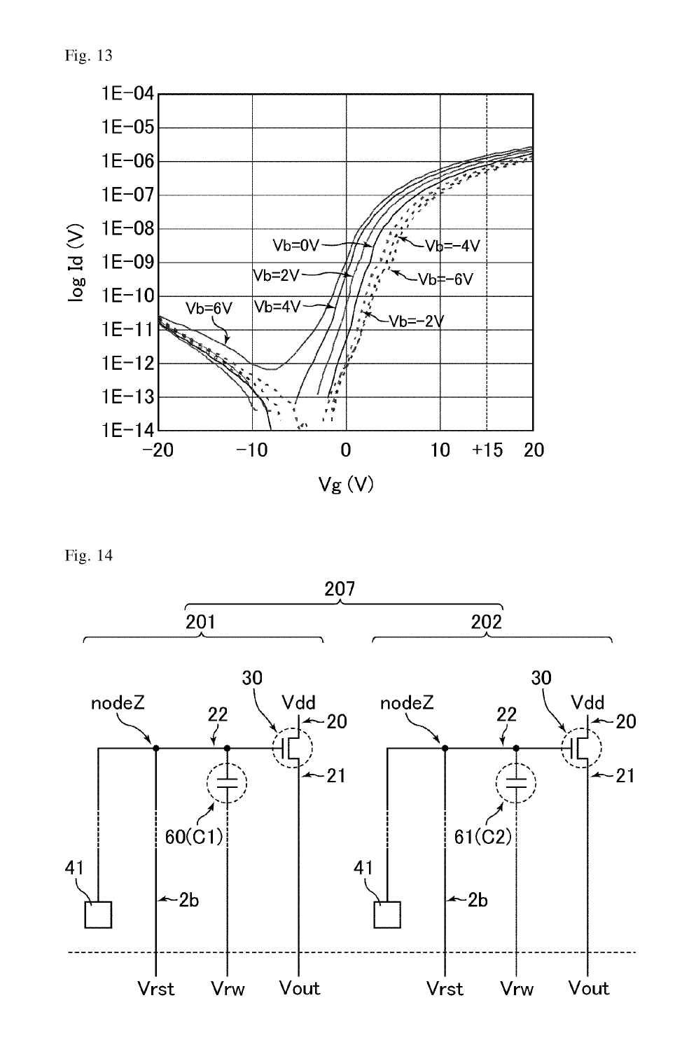

Then, the operation mechanism of the ion sensor circuit is described in detail using FIGS. 9 and 10. FIG. 9 is a timing chart of the ion sensor circuit according to the present embodiment in measuring the negative ion concentration. FIG. 10 is a timing chart of the ion sensor circuit according to the present embodiment in measuring the positive ion concentration.

First, the measurement of the negative ion concentration is described using FIG. 9. In the initial state, Vrst is set to the low voltage (−10 V). At this time, the power supply for setting Vrst to the low voltage (−0 V) can be the power supply for applying the low voltage (−10 V) to the gate electrode 2e of the pixel TFT 40. Also in the initial state, Vdd is set to the low voltage (0 V). Before measurement of the ion concentration, the high voltage (+20 V) is applied to the reset line 2b to reset the voltage (voltage of node-Z) of the antenna 41 to +20 V. At this time, the power supply for setting the reset line 2b to the high voltage (+20 V) can be the power supply for applying the high voltage (+20 V) to the gate electrode 2e of the pixel TFT 40. After the voltage of node-Z is reset, the reset line 2b is maintained in a high impedance state. When ions are started to be introduced and the antenna 41 captures negative ions, the voltage of the node-Z which has been reset to +20 V, i.e., charged to be positive, is neutralized by the negative ions and decreased (sensing operation). A higher negative ion concentration leads to a higher speed of the voltage decrease. After elapse of a predetermined time from introduction of ions, the high voltage (+10 V) is temporarily applied to the input line 20. That is, the input line 20 receives a pulse voltage of 10 V. At the same time, an appropriate negative pulse voltage (low voltage) is applied to the push-up/push-down line 23, such that the voltage of the node-Z is pushed down via the push-up/push-down capacitor 43. The output line 21 is connected to the constant current circuit 25. Therefore, application of a pulse voltage of +10 V to the input line 20 leads to a constant current flow in the input line 20 and the output line 21. The voltage Vout of the output line 21 changes depending on how much the gate of the sensor TFT 30 is opened, i.e., the difference in voltage of the node-Z caused by pushing down the voltage. Detection of the voltage Vout with the ADC 26 enables to detect the negative ion concentration. The negative ion concentration can also be detected by detecting the current Id of the output line 21 changing depending on the difference in node-Z voltage, without provision of the constant current circuit 25. The negative voltage to be applied to the push-up/push-down line 23 is set such that Vg is in the voltage region with the value of ΔId/ΔVg being the desired value or higher, i.e., a high S/N ratio is achieved.

The measurement of the positive ion concentration is described using FIG. 10. In the initial state, Vrst is set to the high voltage (+20 V). At this time, the power supply for setting Vrst to the high voltage (+20 V) can be the power supply for applying the high voltage (+20 V) to the gate electrode 2e of the pixel TFT 40. Also in the initial state, Vdd is set to the low voltage (0 V). Before measurement of the ion concentration, the low voltage (−10 V) is applied to the reset line 2b to reset the voltage (voltage of node-Z) of the antenna 41 to −10 V. At this time, the power supply for setting the reset line 2b to the low voltage (−10 V) to the gate electrode 2e of pixel TFT 40 can be the power supply for applying the low voltage (−10 V) to the gate electrode 2e of the pixel TFT 40. After the voltage of node-Z is reset, the reset line 2b is maintained in a high impedance state. When ions are started to be introduced and the antenna 41 captures positive ions, the voltage of the node-Z which has been reset to −10 V, i.e., charged to be negative, is neutralized by the positive ions and increased (sensing operation). A higher positive ion concentration leads to a higher speed of the voltage increase. After elapse of a predetermined time from introduction of ions, a high voltage (+10 V) is temporarily applied to the input line 20. That is, the input line 20 receives a pulse voltage of 10 V. At the same time, an appropriate negative pulse voltage (low voltage) is applied to the push-up/push-down line 23, such that the voltage of the node-Z is pushed down via the push-up/push-down capacitor 43. The output line 21 is connected to the constant current circuit 25.

Therefore, application of a pulse voltage of +10 V to the input line 20 leads to a constant current flow in the input line 20 and the output line 21. The voltage Vout of the output line 21 changes depending on how much the gate of the sensor TFT 30 is opened, i.e., the difference in voltage of the node-Z caused by pushing down the voltage. Detection of the voltage Vout with the ADC 26 enables to detect the positive ion concentration. The positive ion concentration can also be detected by detecting the current Id of the output line 21 changing depending on the difference in node-Z voltage, without provision of the constant current circuit 25. The negative voltage to be applied to the push-up/push-down line 23 is set such that

Vg is in the voltage region with the value of ΔId/ΔVg being the desired value or higher, i.e., a high S/N ratio is achieved. Therefore, the voltage of the node-Z is not necessarily pushed down if Vg is in the voltage region suitable for detection of the positive ion concentration without pushing down the voltage of the node-Z.

In the present embodiment, the high voltage for Vdd is not particularly limited to +10 V, and may be +20 V which is the same as the high voltage applied to the reset line 2b, i.e., the high voltage applied to the gate electrode 2e of the pixel TFT 40. In this case, the power supply for setting Vdd to the high voltage can be the power supply for applying the high voltage to the gate electrode 2e of the pixel TFT 40. The voltage (high voltage for Vrw) of the push-up/push-down line 23 without pushing down the voltage of the node-Z may be +20 V which is the same as the high voltage applied to the gate electrode 2e of the pixel TFT 40. At this time, the power supply for setting Vrw to the high voltage can be the power supply for applying the high voltage to the gate electrode 2e of the pixel TFT 40. The voltage (low voltage for Vrw) of the push-up/push-down line 23 in pushing down the voltage of the node-Z is appropriately set such that the value of ΔId/ΔVg is large as described above.

As described above, the ion sensors according to Embodiments 1 and 2 and the display devices provided with the respective ion sensors can detect both positive ions and negative ions with high precision by pushing up or pushing down the voltage of the node-Z, using only one of either N-channel TFTs or the P-channel TFTs.

In Embodiments 1 and 2, the voltage in pushing up or pushing down the node-Z is determined from the formula (capacitance of push-up/push-down capacitor 43)/(total capacitance of node-Z)×ΔVpp, wherein ΔVpp is a difference between the high voltage for Vrw and the low voltage for Vrw. The voltage to be pushed up or pushed down of the node-Z can be adjusted by controlling the capacitance of the push-up/push-down capacitor 43 and/or ΔVpp in Embodiments 1 and 2.

In the following, an alternative embodiment of Embodiments 1 and 2 is described.

As mentioned above, the voltage to be pushed up or pushed down of the node-Z changes also in accordance with the capacitance of the push-up/push-down capacitor 43. The capacitances of the push-up/push-down capacitors of the negative ion detection circuit and the positive ion detection circuit may therefore be different from each other such that the node-Z voltage in each of the circuits is optimal.

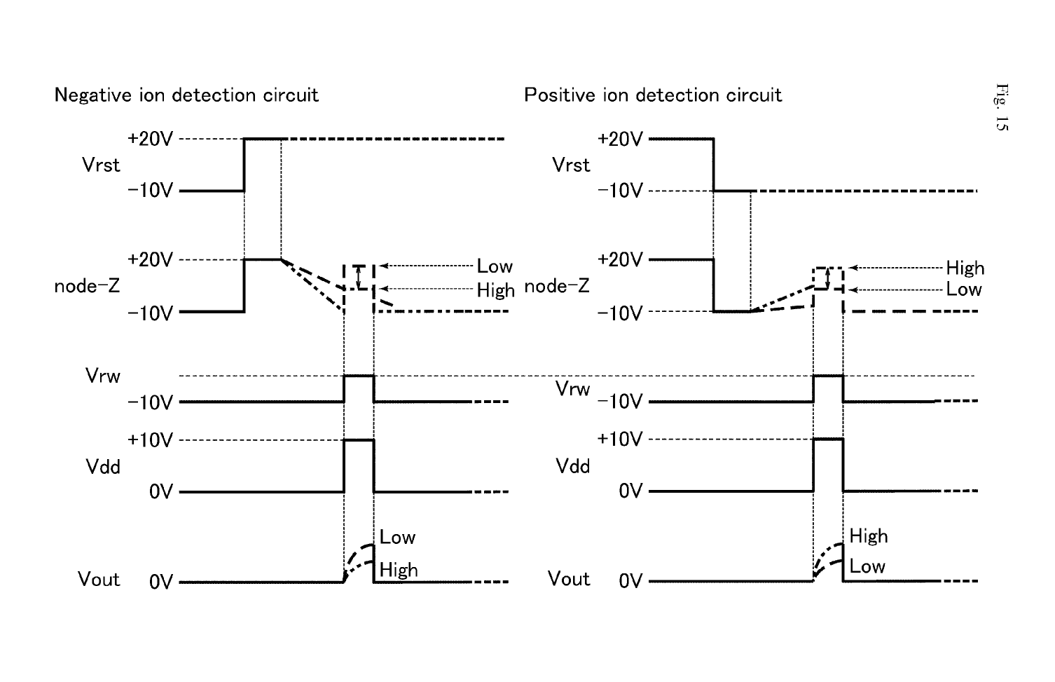

The case of applying the present alternative embodiment to Embodiment 1 is further described in detail using FIGS. 14 and 15. The present alternative embodiment can also be applied to Embodiment 2 based on the same concept. FIG. 14 is a view illustrating an equivalent circuit of the ion sensor circuit 207 according to the alternative embodiment.

The ion sensor circuit 207 includes the negative ion detection circuit 201 and the positive ion detection circuit 202. The circuit 201 includes the sensor TFT (first FET) 30, the ion sensor antenna (first ion sensor antenna) 41, and a push-up/push-down capacitor 60 (first capacitor). The circuit 202 includes the sensor TFT (second FET) 30, the ion sensor antenna (second ion sensor antenna) 41, and a push-up/push-down capacitor 61 (second capacitor). The circuits 201 and 202 are the same as the ion sensor circuit 107 of Embodiment 1, except for including the push-up/push-down capacitors 60 and 61 in place of the push-up/push-down capacitor 43. The capacitance (C1) of the capacitor 60 and the capacitance (C2) of the capacitor 61 are set to respective values different from each other. C1 is set to an optimal value for detecting negative ions, and C2 is set to an optimal value for detecting positive ions.

FIG. 15 is a timing chart of the negative ion detection circuit and the positive ion detection circuit according to the alternative embodiment. The waveform of the pulse voltage (waveform of Vrw) applied to the capacitor 61 and the waveform of the pulse voltage (waveform of Vrw) applied to the capacitor 60 are the same as each other. The circuits 201 and 202 can use the common power supply. Since C1 and C2 are different from each other, the voltages to be pushed up of the node-Zs in the circuit 201 and the circuit 202 are different from each other. The optimal voltages to be pushed up of the node-Zs in the respective circuits can be achieved.

In the present alternative embodiment, the waveforms of Vrw in the circuits 201 and 202 can be further differentiated from each other to adjust the voltage to be pushed up of the node-Z.

The liquid crystal display devices used for describing Embodiments 1 and 2 may be FPDs such as an organic electroluminescence display and a plasma display.

The constant current circuit 25 may not be provided. That is, the ion concentration may be calculated by measuring the current between the source and drain of the sensor TFT 30.

The conduction type of the TFTs formed in the ion sensor 120 and the conduction type of the TFTs formed in the display 130 may be different from each other.

A μc-Si layer, p-Si layer, CG-Si layer, or an oxide semiconductor layer may be used instead of the a-Si layer. Since μc-Si is highly sensitive to light as a-Si is, TFTs including a μc-Si layer are preferably shielded from light. In contrast, p-Si, CG-Si, and an oxide semiconductor have a low sensitivity to light, and thus TFTs including a p-Si layer or CG-Si layer may not be shielded from light.

The kind of the semiconductor for TFTs formed in the ion sensor 120 and the kind of the semiconductor for TFTs formed in the display 130 may be different from each other, but are preferably the same as each other, for simplification of the production process.

The TFTs formed on the substrate 1a are not limited to bottom-gate TFTs, and may be top-gate TFTs or planer TFTs. For example, when the sensor TFT 30 is of a planer type, the antenna 41 may be formed over the channel region of the TFT 30. That is, the gate electrode 2d may be exposed and the gate electrode 2d itself may be configured to function as an ion sensor antenna.

The TFTs formed in the ion sensor 120 and the TFTs formed in the display 130 may be different from each other.

The gate driver 103, the source driver 104, and the driving/reading circuit 105 may be monolithic, and directly formed on the substrate 1a.

Embodiments 1 and 2 employ an example of an ion sensor that measures the positive or negative ion concentration in the air. The subject of the measurement by the ion sensor of the present invention is not limited to ions in the air, but may be ions in a solution.

Specifically, the ion sensor may function as a biosensor for detecting protein, DNA, or an antibody.

The above embodiments may be appropriately combined with each other without departing from the scope of the present invention.

The present application claims priority to Patent Application No. 2010-128167 filed in Japan on Jun. 3, 2010 under the Paris Convention and provisions of national law in a designated State, the entire contents of which are hereby incorporated by reference.

### REFERENCE SIGNS LIST

1a, 1b: Insulating substrate
2a: Ion sensor antenna electrode
2b: Reset line
2c, 8: Push-up/push-down capacitor electrode
2d, 2e, 51: Gate electrode
3, 52, 57: Insulating film
4a, 4b, 53: Hydrogenated a-Si layer
5a, 5b, a 54: n+a-Si layer
6a, 6b, 55: Source electrode
7a, 7b, 56: Drain electrode
9: Passivation Film
10a, 10b: Contact hole
11a: Transparent conductive film (first transparent conductive film)
11b: Transparent conductive film (second transparent conductive film)
12a: Light-shielding film (first light-shielding film)
12b: Light-shielding film (second light-shielding film)
13: Color filter
20: Input line
21: Output line
22: Connection line
23: Push-up/push-down line
25: Constant current circuit
26: Analog-digital conversion circuit (ADC)
30: Sensor TFT (first FET, second FET)
31a, 31b: Polarizer
32: Liquid crystal
36: Liquid crystal storage capacitor (Cs)
40: Pixel TFT (third FET)
41: Ion sensor antenna (first ion sensor antenna, second ion sensor antenna)
42: Air ion lead-in/lead-out path
43: Push-up/push-down capacitor
50: TFT
58: Back gate electrode
59: Substrate
60: Push-up/push-down capacitor (first capacitor)
61: Push-up/push-down capacitor (second capacitor)
62, 63, 64: Power supply
65, 66, 67, 68, 69: Switch
101: Display-driving TFT array
103: Gate driver (display scanning signal line-driving circuit)
104: Source Driver (display image signal line-driving circuit)
105: Ion sensor driving/reading circuit
106: Arithmetic processing LSI
107, 207: Ion sensor circuit
109: Power supply circuit
110: Display device
115: Display-driving circuit
120, 125: Ion sensor
130, 135: Display
201: Negative ion-detection circuit
202: Positive ion-detection circuit

1. An ion sensor comprising:
a field effect transistor;
an ion sensor antenna; and
a capacitor,
the ion sensor antenna and one terminal of the capacitor connected to a gate electrode of the field effect transistor,
the other terminal of the capacitor receiving voltage.

2. The ion sensor according to claim 1,
wherein the voltage is variable.

3. The ion sensor according to claim 1,
wherein the field effect transistor is a first field effect transistor,
the ion sensor antenna is a first ion sensor antenna,
the capacitor is a first capacitor,
the ion sensor further comprises a second field effect transistor, a second ion sensor antenna, and a second capacitor,
the second ion sensor antenna and one terminal of the second capacitor are connected to a gate electrode of the second field effect transistor,
the other terminal of the second capacitor receives voltage, and
the first capacitor and the second capacitor are different from each other in capacitance.

4. The ion sensor according to claim 1,
wherein the field effect transistor contains amorphous silicon or microcrystalline silicon.

5. A display device comprising:
the ion sensor according to claim 1;
a display including a display-driving circuit; and
a substrate,
wherein the field effect transistor, the ion sensor antenna, and at least one portion of the display-driving circuit are formed on the same main surface of the substrate.
